(19) United States
(12) Patent Application Publication
(10) Pub. No.: US 2019/0339120 A1
(43) Pub. Date: Nov. 7, 2019

(54) State Monitoring System for Rotating Machine, Method of Monitoring State of Rotating Machine, Program, and Recording Medium

(71) Applicant: OMRON Corporation, Kyoto-shi, Kyoto (JP)

(72) Inventors: Koji YOKOTA, Kusatsu-shi (JP); Yukiyoshi YAMAMOTO, Aso-shi (JP); Taihei YASUDA, Kyoto-shi (JP); Tadahiko OGAWA, Kusatsu-shi (JP); Takahiro NAKAMURA, Kusatsu-shi (JP)

(73) Assignee: OMRON Corporation, Kyoto-shi, Kyoto (JP)

(21) Appl. No.: 16/472,931

(22) PCT Filed: Nov. 16, 2017
(86) PCT No.: PCT/JP2017/041273

§ 371 Date: Jun. 24, 2019

(30) Foreign Application Priority Data
Mar. 13, 2017 (JP) 2017-047083

(51) Int. Cl. G01H 17/00

(52) U.S. Cl. CPC G01H 17/00

(57) ABSTRACT

A state monitoring system for a rotating machine includes: a sensor head; a preamplifier; a main unit; and a temperature sensor The sensor head includes: an acceleration sensor configured to measure vibrations of the motor and output a vibration value; and a temperature sensor configured to measure a surface temperature of the motor and output a rotating machine surface temperature value. The main unit includes: a processor configured to compare a current vibration value with a determination threshold value and determine the state of the motor; a display unit configured to display the vibration value, the rotating machine surface temperature value, and the ambient temperature value; an output unit configured to output a determination result of the processor; and a communication unit configured to receive the determination threshold value from a host system and transmit the current vibration value and the determination result to the host system.

### TECHNIC AL FIELD

The present invention relates to a state monitoring system for a rotating machine, a method of monitoring the state of the rotating machine, a program for causing a computer to execute the method, and a recording medium in which the program is recorded.

### BACKGROUND ART

The technique for diagnosing abnormalities in a rotating machine is known. For example, Japanese Patent Laying-Open No. 2007-10415 (PTL 1) discloses an apparatus and a method for diagnosing an abnormality in a bearing portion of a rotating machine. An abnormality diagnosing apparatus is configured to measure vibrations occurring in the bearing portion of the rotating machine to compare a representative value calculated from the measured vibration data with a diagnostic threshold value registered in advance, thereby determining whether an abnormality occurs or not in the bearing portion.

### CITATION LIST

### Patent Literature

PTL 1: Japanese Patent Laying-Open No. 2007-10415

### SUMMARY OF INVENTION

### Technical Problem

As disclosed in Japanese Patent Laying-Open No. 2007-10415 (PTL 1), only the vibration value is used for determination about an abnormality in the rotating machine. However, the determination based only on the vibration value causes a problem that the reliability of the determination result is relatively low.

An object of the present invention is to provide a technique regarding monitoring of the state of a rotating machine for highly reliably determining occurrence of an abnormality in a rotating machine.

### Solution To Problem

A state monitoring system for a rotating machine according to an aspect of the present invention includes: a sensor head that is attachable to a rotating machine, a preamplifier, a main unit, and a second temperature sensor provided in the preamplifier or the main unit, the second temperature sensor being configured to measure an ambient temperature of the rotating machine and output an ambient temperature value. The sensor head includes an acceleration sensor configured to measure vibrations of the rotating machine and output a vibration value, and a first temperature sensor configured to measure a surface temperature of the rotating machine and output a rotating machine surface temperature value. The preamplifier is configured to relay the vibration value from the acceleration sensor and the rotating machine surface temperature value from the first temperature sensor. The main unit includes: a processor configured to compare a current (present) vibration value with a determination threshold value and determine a state of the rotating machine; a display unit configured to display the vibration value, the rotating machine surface temperature value and the ambient temperature value; an output unit configured to output a determination result of the processor; and a communication unit configured to receive the determination threshold value from a host system and transmit the current vibration value and the determination result to the host system.

Preferably, the second temperature sensor is incorporated in the preamplifier. The preamplifier is configured to amplify an analog signal output from each of the acceleration sensor, the first temperature sensor and the second temperature sensor, and convert the amplified analog signal into a digital signal.

Preferably, the second temperature sensor is incorporated in the main unit. The preamplifier is configured to amplify an analog signal output from each of the acceleration sensor and the first temperature sensor, and convert the amplified analog signal into a digital signal. The main unit is configured to amplify an analog signal output from the second temperature sensor and convert the amplified analog signal into a digital signal.

Preferably, the state monitoring system for a rotating machine further includes: a cable through which an analog signal output from the sensor head is transmitted to the preamplifier; and a connector through which the sensor head is connectable to the cable and through which the sensor head is removable from the cable.

A method of monitoring a state of a rotating machine according to an aspect of the present invention includes: acquiring, by a processor, a vibration value and a rotating machine surface temperature value from a sensor head that is attachable to a rotating machine, the sensor head including an acceleration sensor configured to measure vibrations of the rotating machine and a first temperature sensor configured to measure a surface temperature of the rotating machine; acquiring, by the processor, an ambient temperature value from a second temperature sensor configured to measure an ambient temperature of the rotating machine; comparing, by the processor, a current vibration value with a determination threshold value and determining a state of the rotating machine; displaying, by a display unit, the vibration value, the rotating machine surface temperature value and the ambient temperature value; outputting, by an output unit, a determination result of the processor; and receiving, by a communication unit, the determination threshold value from a host system.

A program according to an aspect of the present invention causes a computer to perform: acquiring a vibration value and a rotating machine surface temperature value from a sensor head that is attachable to a rotating machine, the sensor head including an acceleration sensor configured to measure vibrations of the rotating machine and a first temperature sensor configured to measure a surface temperature of the rotating machine; acquiring an ambient temperature value from a second temperature sensor configured to measure an ambient temperature of the rotating machine; comparing a current vibration value with a determination threshold value and determining a state of the rotating machine; displaying, by a display unit, the vibration value, the rotating machine surface temperature value and the ambient temperature value; outputting, by an output unit, a determination result acquired by the determining; and receiving, by a communication unit, the determination threshold value from a host system.

A recording medium according to an aspect of the present invention is a non-transitory computer-readable recording medium in which the above-mentioned program is recorded.

### Advantageous Effects of the Invention

According to the present invention, the temperature of the rotating machine itself and the ambient temperature of the rotating machine can be simultaneously measured in addition to the vibration value of the rotating machine. When it is determined based on the vibration value whether an abnormality occurs or not in the rotating machine, the temperature of the rotating machine and the ambient temperature of the rotating machine can be taken into consideration. Accordingly, the reliability of determination about an abnormality in the rotating machine can be improved.

### BRIEF DESCRIPTION OF DRAWINGS

FIG. 1 is a schematic diagram of the configuration of a state monitoring system for a rotating machine according to one embodiment of the present invention.

FIG. 2 is a diagram showing an example of a sensor head shown in FIG. 1.

FIG. 3 is a block diagram of the state monitoring system shown in FIG. 1.

FIG. 4 is a diagram illustrating the first mode of two modes for state monitoring.

FIG. 5 is a diagram illustrating the second mode of two modes for state monitoring.

FIG. 6 is a graph showing a change in vibration value with respect to the operating times of two motors.

FIG. 7 is a diagram showing the first example of a surface temperature (motor temperature) and an ambient temperature of each of two motors in tabular form.

FIG. 8 is a diagram showing the second example of a surface temperature (motor temperature) and an ambient temperature of each of two motors in tabular form.

FIG. 9 is a diagram showing an example of tendencies of the vibration value, the motor temperature, and the ambient temperature.

FIG. 10 is a block diagram of the state monitoring system according to an embodiment of the present invention.

FIG. 11 is a flowchart for illustrating a monitoring process and an abnormality determination process that are performed by the state monitoring system.

### DESCRIPTION OF EMBODIMENTS

The embodiments of the present invention will be hereinafter described in detail with reference to the accompanying drawings, in which the same or corresponding components will be designated by the same reference characters, and description thereof will not be repeated.

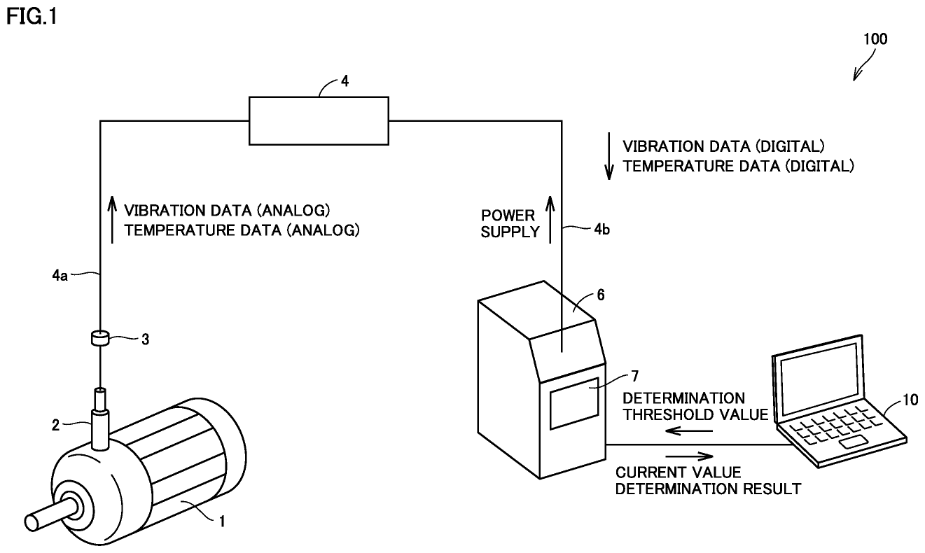

FIG. 1 is a schematic diagram of the configuration of a state monitoring system for a rotating machine according to one embodiment of the present invention. As shown in FIG. 1, a state monitoring system 100 includes a sensor head 2, a preamplifier 4, and a main unit 6. Sensor head 2 is connected to preamplifier 4 through a connector 3 and a cable 4a. Preamplifier 4 is connected to main unit 6 through a cable 4b.

Sensor head 2 is attached to the surface of a motor (rotating machine) 1, and measures the number of vibrations of motor 1 and the surface temperature of motor 1. Sensor head 2 outputs the vibration data showing the number of vibrations of motor 1 and the temperature data showing the surface temperature of motor 1 in the form of an analog signal.

Preamplifier 4 receives a power supply voltage from main unit 6 through cable 4b. Preamplifier 4 receives the vibration data and the temperature data from sensor head 2 and converts the received data into digital data.

Preamplifier 4 further measures the ambient temperature of motor 1. Preamplifier 4 transmits the vibration data showing the number of vibrations of motor 1, the temperature data showing the surface temperature of motor 1, and the temperature data showing the ambient temperature of motor 1 to main unit 6 through cable 4b,

Main unit 6 includes a display unit 7. Display unit 7 displays the data about the number of vibrations of motor 1, the temperature data about the surface temperature of motor 1, and the temperature data about the ambient temperature of motor 1. Furthermore, main unit 6 compares the vibration data with a determination threshold value to determine whether motor 1 normally operates or not. Main unit 6 can cause display unit 7 to display the determination result.

Main unit 6 is connected to a host system 10 and receives the determination threshold value from host system 10. The determination threshold value is input, for example, by a user into host system 10 and transmitted from host system 10 to main unit 6. On the other hand, main unit 6 transmits the current vibration value and the current temperature value to host system 10. Furthermore, main unit 6 transmits the determination result about the state of motor 1 to host system 10.

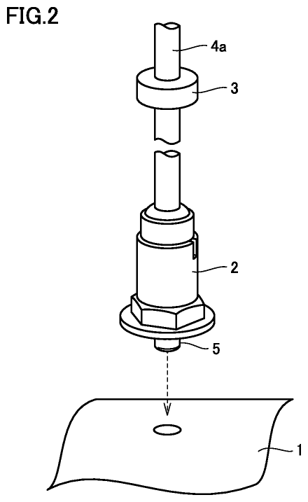

FIG. 2 is a diagram showing an example of the sensor head shown in FIG. 1. As shown in FIG. 2, sensor head 2 includes a thread portion 5 through which sensor head 2 is attached to the surface of motor 1. As described later, an acceleration sensor and a temperature sensor are incorporated in sensor head 2. Sensor head 2 is attached to the surface of motor 1, so that the acceleration sensor and the temperature sensor come into contact with the surface of motor 1. In consideration of the installation environment of motor 1, sensor head 2 is configured to have a protection structure having dust resistance, waterproofness, and oil resistance.

According to the present embodiment, connector 3 allows sensor head 2 to be connectable to cable 4a and also to be removable from cable 4a. When sensor head 2 is attached to motor 1 or when sensor head 2 is removed form motor 1, sensor head 2 needs to be rotated. In the case where sensor head 2 remains connected to cable 4a, rotation of sensor head 2 may twist cable 4a. By rotating sensor head 2 in the state where sensor head 2 is removed from connector 3, twisting of cable 4a can be prevented. Thus, for example, also when cable 4a is routed through a duct, sensor head 2 can be readily replaced.

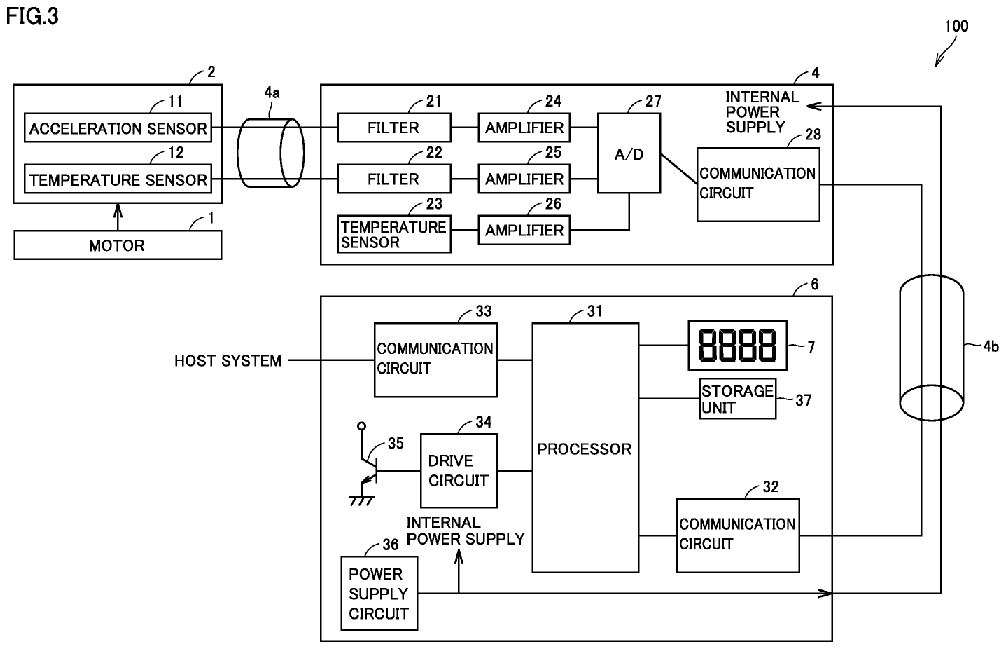

FIG. 3 is a block diagram of a state monitoring system 100 shown in FIG. 1. As shown in FIG. 3, sensor head 2 includes an acceleration sensor 11 and a temperature sensor 12. Acceleration sensor 11 serves to detect vibrations of motor 1. Acceleration sensor 11 can detect the vibration frequency up to 10 kHz, the vibration acceleration in the range of 0.5 (3 to 10 G, and the vibration velocity in the range of 0.5 m/s to 100 m/s, for example. Temperature sensor 12 serves to detect the surface temperature of motor 1.

Preamplifier 4 includes filters 21, 22, a temperature sensor 23, amplifiers 24, 25, 26, an A/D converter 27, and a communication circuit 28. Filter 21 removes the noise contained in the analog signal (vibration data) transmitted from acceleration sensor 11 through cable 4a. Filter 22 removes the noise contained in the analog signal (temperature data) transmitted from temperature sensor 12 through cable 4a. Amplifiers 24 and 25 amplify the analog signals that have passed through filters 21 and 22, respectively. Thus, it can also be said that preamplifier 4 serves to relay the vibration value from acceleration sensor 11 and the rotating machine surface temperature value from temperature sensor 12.

Temperature sensor 23 detects the ambient temperature of motor 1 and outputs the analog signal representing the detected temperature. Amplifier 26 amplifies the analog signal output from temperature sensor 23.

A/D converter 27 converts the analog signal output from each of amplifiers 24, 25 and 26 into a digital signal. Communication circuit 28 transmits the digital signal output from A/D converter 27 through cable 4b to main unit 6.

Main unit 6 includes display unit 7, a processor 31, communication circuits 32, 33, a drive circuit 34, an output unit 35, a power supply circuit 36, and a storage unit 37. Processor 31 is implemented, for example, by a computing unit (computer) such as a central processing unit (CPU) and configured to read a program from storage unit 37 and execute the program. Communication circuit 32 receives a digital signal (vibration data and temperature data) from preamplifier 4 through cable 4b. Processor 31 causes display unit 7 to display the vibration data and the temperature data. Processor 31 compares the vibration data with a determination threshold value to determine whether an abnormality occurs or not in motor 1. Processor 31 causes display unit 7 to display the determination result and outputs the determination result to a host system through communication circuit 33.

Processor 31 controls drive circuit 34 to drive output unit 35. For example, when it is determined that an abnormality occurs in motor 1, output unit 35 generates an output showing the abnormality.

Power supply circuit 36 supplies an internal power supply for operating main unit 6 to main unit 6 and also supplies an internal power supply for operating preamplifier 4 to preamplifier 4 through cable 4b.

Storage unit 37 serves as a recording medium in which a program for causing processor 31 to operate is stored in a non-volatile manner. The program may be provided from a host system through communication circuit 33 to main unit 6 or may be provided through other recording media (for example, a USB memory and the like) to main unit 6. Furthermore, storage unit 37 may be integrated into processor 31.

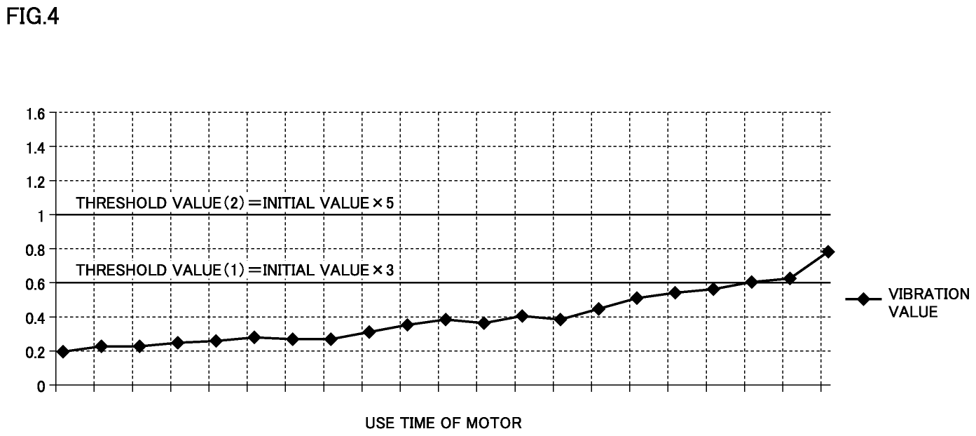

According to the present embodiment, the state monitoring system can have one or both of two modes for state monitoring, which will be described below. FIG. 4 is a diagram illustrating the first mode of these two modes for state monitoring.

As shown in FIG. 4, the tendency of the vibration acceleration is monitored in the first mode. In the first mode, the value (initial value) of the vibration acceleration in a brand-new motor is compared with the current (present) value of the vibration acceleration.

The value of the vibration acceleration increases as the use time of the motor elapses. Two determination threshold values are set for the ratio of the current value to the initial value. In the example shown in FIG. 4, the first threshold value (a threshold value (1)) is set at a value that is three times as high as the initial value while the second threshold value (a threshold value (2)) is set at a value that is five times as high as the initial value. When the current value exceeds the threshold value (1), it is determined that motor 1 is in the state of a caution level. Furthermore, when the current value exceeds the threshold value (2), it is determined that motor 1 is in the state of an abnormal level.

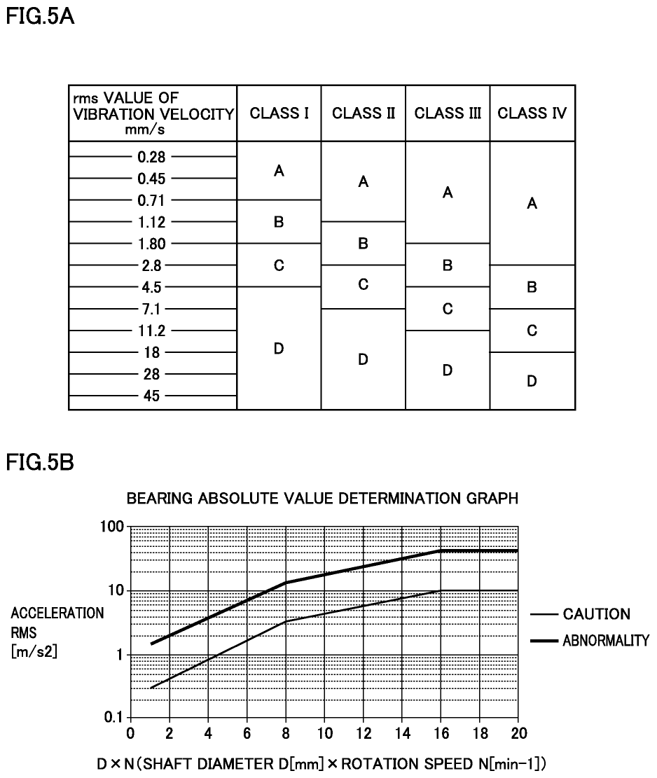

FIG. 5 is a diagram illustrating the second mode of two modes for state monitoring. As shown in FIG. 5, the state of motor 1 is determined by comparing the vibration level value with the standards (for example, ISO standards, JIS standards or the like) or the reference that is independently set. For example, as shown in FIG. 5(a), for determining the state of the portion of motor 1 other than the bearing, it is determined based on the vibration velocity value as to which level of A to D the current level of the motor corresponds. “Class I” to “Class IV” in FIG. 5(a) represent the classification based on the rating and the like of the motor. For determining the state of the bearing, the vibration acceleration is monitored, for example, as shown in FIG. 5(b). The vibration acceleration relative to the product of the shaft, diameter and the rotation speed is determined based on the reference. In this mode, the state of motor 1 can be determined even when the vibration velocity or the vibration acceleration of a brand-new motor 1 is unclear.

In these two modes, the determination threshold value may be a predetermined value. The determination threshold value in this case is merely a rough indicator value. The user may adjust the determination threshold value in accordance with the status of use of motor 1.

By considering the temperature value in the above-mentioned two modes, the accuracy of setting the threshold value can be improved. For example, in the case of not a brand-new motor, the vibration value and the motor surface temperature show the following values immediately after start of driving and after driving for a certain period of time. It is to he noted that the following numerical values are shown merely by way of example but do not limit the present invention.

Immediately after start of driving: vibration value 1.75 m/s², motor surface temperature 5° C.

After a lapse of a certain period of time: vibration value 0.46 m/s², motor temperature 40°C. (saturation)

This example shows that the vibration value is dependent on the surface temperature of the motor (the motor temperature). The reason why the vibration value changes depending on the motor temperature is assumed that the viscosity of the lubricating oil in the bearing portion has been changed by the temperature. Since the viscosity of the lubricating oil is relatively high immediately after driving of the motor is started, vibrations are more likely to be transmitted to the housing of the motor. Thus, it is considered that the vibration value is high.

On the other hand, when this motor is installed in an environment where the ambient temperature is high, the above-mentioned change in vibration value may not remarkably occur. When the ambient temperature is high and the temperature of the rotating machine itself is also high, the viscosity of the lubricating oil is relatively low as compared with the viscosity at a low temperature. Thus, the vibration value tends to be low. When the threshold value for abnormality determination is set based only on the vibration value with no consideration of the influence of the temperature, the abnormal state of the rotating machine may be determined as a normal state.

According to the embodiment of the present invention, the state monitoring system for the rotating machine can simultaneously measure the temperature of the rotating machine itself and the ambient temperature of the rotating machine in addition to the vibration value. The user can appropriately set the determination threshold value in consideration of the temperature of the rotating machine itself and the ambient temperature of the rotating machine in addition to the vibration value. Thereby, the reliability of abnormality determination or the rotating machine can he improved. In the following, an example of setting the determination threshold value will be described.

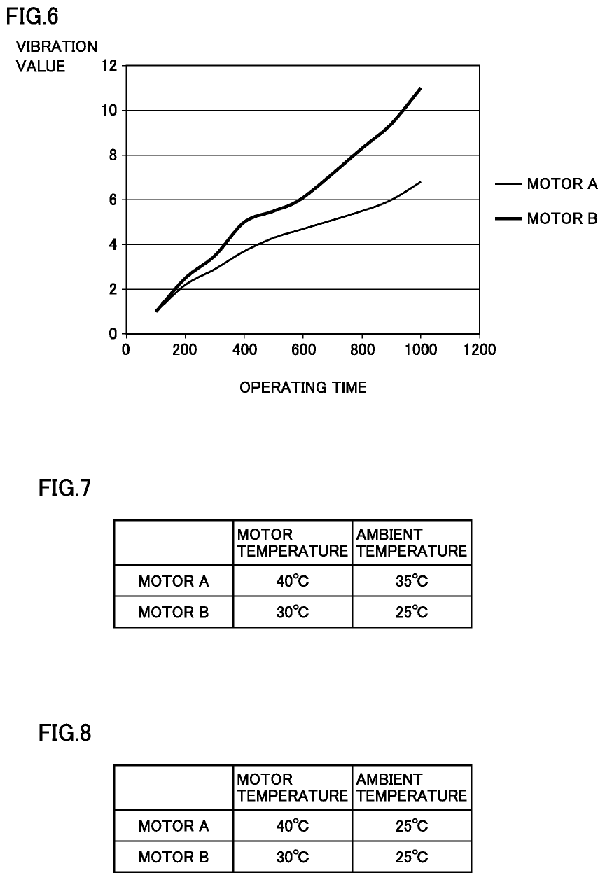

FIG. 6 is a graph showing a change in vibration value with respect to the operating times of two motors. FIG. 7 is a diagram showing the first example of the surface temperature (motor temperature) and the ambient temperature of each of two motors in tabular form. Referring to FIGS. 6 and 7, it is assumed that two motors A and B of the same type are introduced into two apparatuses having the same configuration at the same timing.

in the first example, motor A is higher in motor temperature than motor B. However, the difference between the motor temperature and the ambient temperature is 5° C. in each of these two motors. In this case, it can be determined that the same load is applied to motors A and B, and the motor temperature is influenced by the ambient temperature. The user can determine that the determination threshold value for motor A needs to he lowered below the determination threshold value for motor B. Thereby, the determination threshold value for motor A can be appropriately adjusted.

FIG. 8 is a diagram showing the second example of the surface temperature (motor temperature) and the ambient temperature of each of two motors in tabular form. In the second example, motor A is higher in surface temperature than motor B. The ambient temperature is the same in two motors A and B. In this case, it is estimated that motor A is higher in load than motor B.

As described in the above example, the vibration value is influenced by the temperature. Thus, it is considered that the number of vibrations of motor A tends to decrease as the motor temperature rises. In this case, the user can determine that the determination threshold value for motor A needs to be lowered below the determination threshold value for motor B. Thereby, the determination threshold value for motor A can be appropriately adjusted.

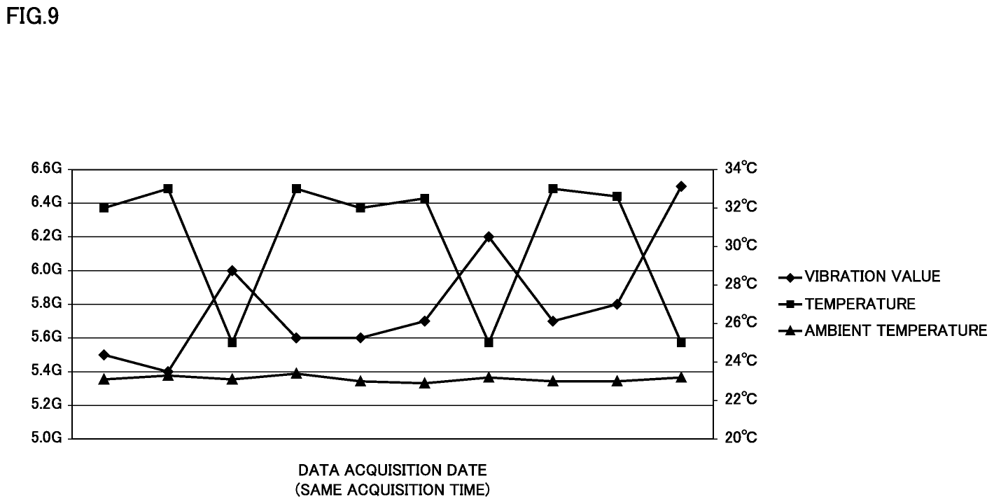

Furthermore, according to the embodiment of the present invention, the data acquisition timing can be changed in consideration of the influence of the temperature. FIG. 9 is a diagram showing an example of tendencies of the vibration value, the motor temperature and the ambient temperature. The data shown in FIG. 9 is acquired at a fixed point of time in one day. As shown in FIG. 9, when the motor temperature is low, the vibration value is high, but there is almost no change in ambient temperature. It is considered that this shows the state where, at the data acquisition time, the load upon the motor is low or activation of the motor has been started.

As described above, the operating state of the motor at the data acquisition time may change day by day in accordance with the operating state of the apparatus, and the like. Thus, the user can notice the need to change the data acquisition timing in accordance with the operating state of the motor. For example, by acquiring data at a timing at which the motor surface temperature is relatively low, the abnormality in the motor can be detected at an early stage.

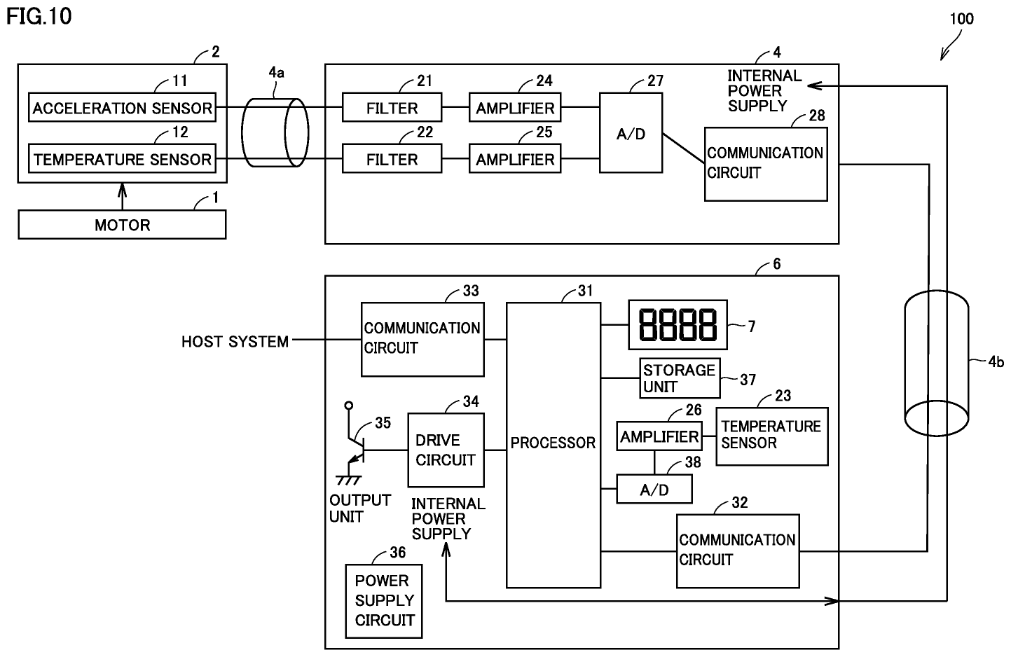

In the configuration shown in FIG. 3, temperature sensor 23 for measuring the ambient temperature of motor 1 is provided in preamplifier 4. However, the embodiment of the present invention is not limited in this way. FIG. 10 is a block diagram of a state monitoring system 100 according to an embodiment of the present invention.

As shown in FIG. 10, temperature sensor 23 may be provided in main unit 6. In the configuration shown in FIG. 10, amplifier 26 for amplifying the output from temperature sensor 23 and an A/D converter 38 for converting the output signal from amplifier 26 into a digital signal are provided in main unit 6. Processor 31 receives the digital signal from A/D converter 38.

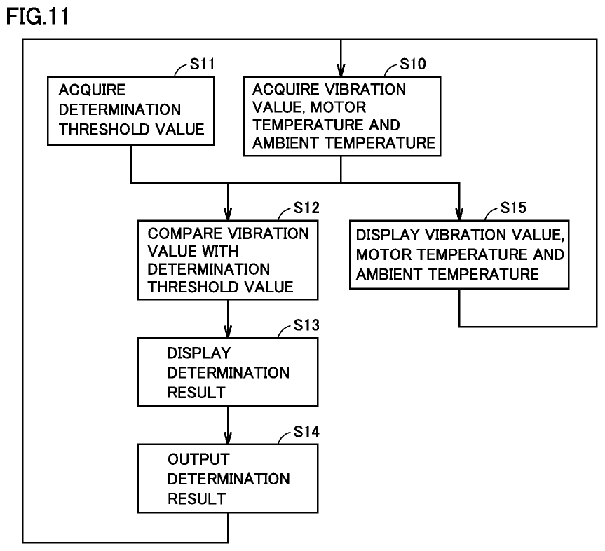

FIG. 11 is a flowchart for illustrating the monitoring process and the abnormality determination process that are performed by state monitoring system 100. Processor 31 in main unit 6 invokes the program stored in storage unit 37 and executes the invoked program. Thereby, the process shown in FIG. 11 is performed.

Referring to FIGS. 3 and 11, in step S10, processor 31 acquires the vibration value of motor 1, the value of the motor temperature of motor 1 and the value of the ambient temperature of motor 1 respectively detected by acceleration sensor 11, temperature sensor 12 and temperature sensor 23. In step S11, processor 31 acquires a determination threshold value from a host system. The timing at which the process in step S11 is performed is not particularly limited. For example, the user's input of the determination threshold value into the host system may trigger transmission of the determination threshold value from the host system to main unit 6.

In step S12, processor 31 compares the vibration value with the determination threshold value to determine the state of motor 1. In step S13, processor 31 causes display unit 7 to display the determination result. Display unit 7 displays the state of motor 1. The display manner is not particularly limited. Furthermore, in step S14, processor 31 outputs the determination result to the outside of main unit 6. For example, processor 31 causes output unit 35 to output the signal representing the determination result to the outside of main unit 6. Processor 31 may transmit the determination result of processor 31 through communication circuit 33 to the host system. Then, the process is returned from step S14 to step S10. Also, only one of steps S13 and S14 may be performed.

Furthermore, in step S15, processor 31 causes display unit 7 to display the vibration value, the value of the surface temperature of motor 1 and the ambient temperature of motor 1, which are acquired in step S11. The display process in step S13 and the display process in step S15 may be simultaneously performed. Alternatively, by user's setting, the display process in step S13 and the display process in step S15 may be switched. After step S15, the process is returned to step S10.

As described above, according to the embodiment of the present invention, the reliability of abnormality determination for the motor can be improved by simultaneously measuring the surface temperature of the motor (rotating machine) itself and the ambient temperature of the motor in addition to the vibration value of the motor.

It should be understood that the embodiments disclosed herein are illustrative and non-restrictive in every respect. The scope of the present invention is defined by the terms of the claims, rather than the description above, and is intended to include any modifications within the meaning and scope equivalent to the terms of the claims.

### REFERENCE SIGNS LIST

1 motor, 2 sensor head, 3 connector, 4 preamplifier, 4a, 4b cable, 5 thread portion, 6 main unit, 7 display unit, 10 host system, 11 acceleration sensor, 12, 23 temperature sensor, 21, 22 filter, 24, 25, 26 amplifier, 27, 38 A/D converter, 28, 32, 33 communication circuit, 31 processor, 34 drive circuit, 35 output unit, 36 power supply circuit, 37 storage unit, 100 state monitoring system, S10, S11, S12, S13, S14, S15 step.

1. A state monitoring system for a rotating machine, the state monitoring system comprising:
a sensor head that is attachable to a rotating machine, the sensor head including
an acceleration sensor configured to measure vibrations of the rotating machine and output a vibration value, and
a first temperature sensor configured to measure a surface temperature of the rotating machine and output a rotating machine surface temperature value;
a preamplifier configured to relay the vibration value from the acceleration sensor and the rotating machine surface temperature value from the first temperature sensor;
a main unit; and
a second temperature sensor provided in the preamplifier or the main unit, the second temperature sensor being configured to measure an ambient temperature of the rotating machine and output an ambient temperature value,
the main unit including
a processor configured to compare a current vibration value with a determination threshold value, and determine a state of the rotating machine,
a display unit configured to display the vibration value, the rotating machine surface temperature value and the ambient temperature value,
an output unit configured to output a determination result of the processor, and
a communication unit configured to receive the determination threshold value from a host system, and transmit the current vibration value and the determination result to the host system.

2. The state monitoring system for a rotating machine according to claim 1, wherein
the second temperature sensor is incorporated in the preamplifier, and
the preamplifier is configured to
amplify an analog signal output from each of the acceleration sensor, the first temperature sensor and the second temperature sensor, and
convert the amplified analog signal into a digital signal.

3. The state monitoring system for a rotating machine according to claim 1, wherein
the second temperature sensor is incorporated in the main unit,
the preamplifier is configured to
amplify an analog signal output from each of the acceleration sensor and the first temperature sensor, and
convert the amplified analog signal into a digital signal, and the main unit is configured to
amplify an analog signal output from the second temperature sensor, and
convert the amplified analog signal into a digital signal.

4. The state monitoring system for a rotating machine according to claim 1, further comprising:
a cable through which an analog signal output from the sensor head is transmitted to the preamplifier; and
a connector through which the sensor head is connectable to the cable and through which the sensor head is removable from the cable.

5. A method of monitoring a state of a rotating machine, the method comprising:
acquiring, by a processor, a vibration value and a rotating machine surface temperature value from a sensor head that is attachable to a rotating machine, the sensor head including
an acceleration sensor configured to measure vibrations of the rotating machine, and
a first temperature sensor configured to measure a surface temperature of the rotating machine;
acquiring, by the processor, an ambient temperature value from a second temperature sensor configured to measure an ambient temperature of the rotating machine;
comparing, by the processor, a current vibration value with a determination threshold value and determining a state of the rotating machine;
displaying, by a display unit, the vibration value, the rotating machine surface temperature value and the ambient temperature value;
outputting, by an output unit, a determination result of the processor; and
receiving, by a communication unit, the determination threshold value from a host system.

6. (canceled)

7. A non-transitory computer-readable storage medium storing a program causing a computer to perform:
acquiring a vibration value and a rotating machine surface temperature value from a sensor head that is attachable to a rotating machine, the sensor head including
an acceleration sensor configured to measure vibrations of the rotating machine, and
a first temperature sensor configured to measure a surface temperature of the rotating machine;
acquiring an ambient temperature value from a second temperature sensor configured to measure an ambient temperature of the rotating machine;
comparing a current vibration value with a determination threshold value and determining a state of the rotating machine;
displaying, by a display unit, the vibration value, the rotating machine surface temperature value and the ambient temperature value;
outputting, by an output unit, a determination result acquired by the determining; and
receiving, by a communication unit, the determination threshold value from a host system.
